(19) United States
(12) Patent Application Publication
(10) Pub. No.: US 2007/0137340 A1
(43) Pub. Date: Jun. 21, 2007

(54) Shift device for a transmission

(76) Inventors: Eckhardt Lubke, Friedrichshafen (DE); Frank-Detlef Speck, Friedrichshafen (DE)

Correspondence Address: DAVIS & BUJOLD, P.L.L.C., 112 PLEASANT STREET, CONCORD, NH, 03301, US

(21) Appl. No.: 10/562,028

(22) PCT Filed: Jun. 7, 2004
(86) PCT No.: PCT/EP04/06120

§ 371 Date: Dec. 23, 2005

(30) Foreign Application Priority Data
Jul. 4, 2003 (DE) 103 30 158.5

(51) Int. Cl. F16H 59/00

(52) U.S. Cl. 74/337.5

(57) ABSTRACT

A shift device for a transmission with a cam drive, which has a shifting roll, which is guided to be rotatable about an axle, as well as selector fingers, which engage themselves in grooves and are controllingly conducted therein. On the outer circumference of the shifting roll are rocker elements (8) with wedge-shaped tips at both ends. The rocker elements are rotatably supported on an axle (6) in such a manner that the tips can engage themselves in corresponding grooves in the shifting roll. To this purpose a compression spring (9) is provided. Upon rapid turning of the shifting roll, the effect of the engendered centrifugal force is such that the tips are no longer engaged in the grooves.

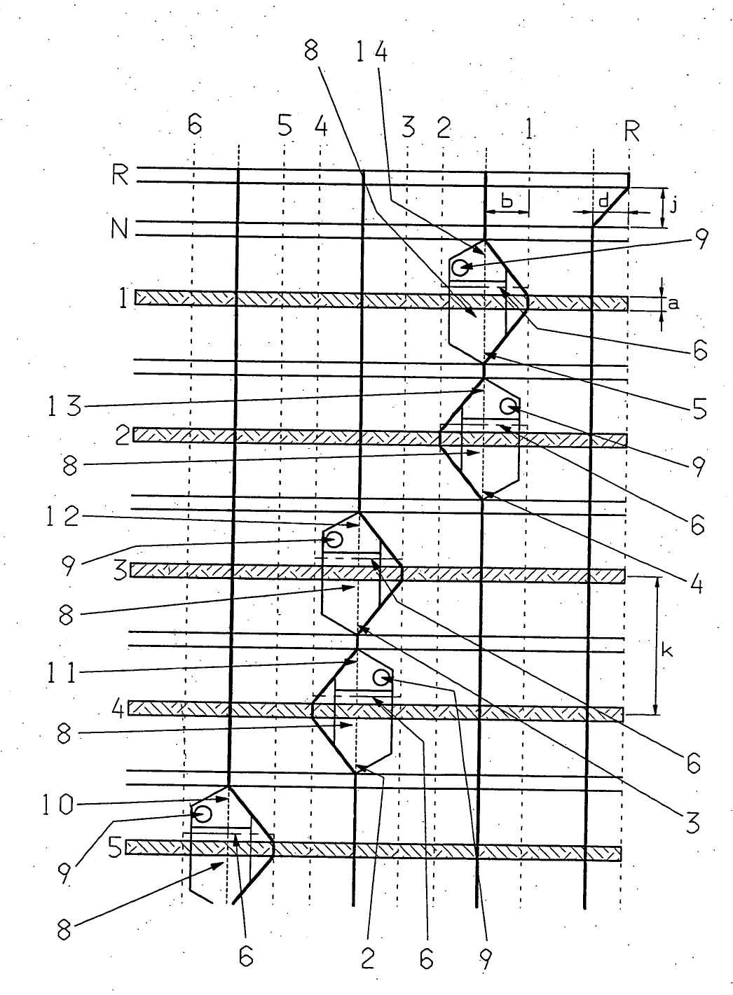

This application is a national stage completion of PCT/EP2004/006120 filed Jun. 7, 2004 which claims priority from German Application Serial No. 103 30 158.5 filed Jul. 4, 2003.

### FIELD OF THE INVENTION

The present invention concerns a shift device for a transmission with a cam drive, which has a shifting roll guidedly rotatable about an axle, as well as selector fingers which engage in grooves on said shifting roll and are regulated therein.

### BACKGROUND OF THE INVENTION

Known to the practice are shift devices for speed-changing transmissions for motor vehicles, which have a cam drive for creating movements of the shifting forks, which are connected to selector fingers. The control contouring of the cam drive is in the form of grooves on the circumference of the shifting roll whereby a control curve has been designed for each shifting form. The selector finger, which is linked to the shifting fork, engages itself in such a manner, that upon rotation of the shifting roll, a continuing shifting motion in an axial direction of the shifting roll is made available on the selector fingers which motion runs from downshift to an upshift gear stage or conversely from an upshift stage into a downshift stage. During the shifting operation, the shifting forks, respectively, run through an idling position between two gear stages.

In the case of multiple-downshifts, these shift devices have the disadvantage that a fixed sequence of shifting operations must be observed. This means that, in the case of a multiple-downshifting, continually one gear stage after another must be engaged and then disengaged, until the desired gear stage is activated in the transmission. The sequential succession of shifts leads to a considerable prolongation of the total time of shifting.

In the case of multiple-downshifting, in order to overcome this disadvantage, the practice has moved in a direction, wherein the desired gear stage is selected in a direct manner that means without a sequential run of shifts in the transmission. For this purpose, the shifting forks, in the case of multiple-downshifting, which are in a position corresponding to the actual shifted-into gear stage, are taken out of the present engagement with the shifting roll and guided into their neutral position with the aid of equipment adapted to that purpose.

Subsequently, the shifting roll has rotated so far in the direction of the downshifting that the position, corresponding to the shifting forks for the desired gear stage has been attained and the shifting forks can be run out of their neutral position. By way of this method of operation, in the case of multiple-downshifting, the sequential shifting through each gear stage is redundant, whereby in this multiple-downshifting through several gear stages, that is “gear jumps”, considerably shorter shifting times are achieved.

DE 195 09 477 teaches of a shift device wherein, during multiple-downshifting, the shifting equipment, which finds itself in its idling position, is brought out of engagement with the controlling cam, whereby a movement of the shifting equipment into a shifting direction out of the idling position is blocked and the shifting roll, without releasing interposed shifting in the transmission, turns into the desired positions.

After this, the shifting equipment is once again brought into its engagement with the cam control of the of the shifting roll.

At the base of the controlling cams are provided traversable ramps in the direction of shifting roll rotation for downshifting. These are situated in front of the shifting path curvature of the cam control so that the selector fingers are blocked from the shifting direction by a restraining apparatus during multiple-downshifting as they approach these ramps.

The above situation still has the disadvantage that, during a traversing of the ramps to achieve the blocking by the restraining apparatus, which is provided with the shifting forks and which forks, in turn, are bound to the selector fingers, the system is burdened by complex construction, whereby high fabrication costs are caused and additional controls must be provided.

In order to avoid this disadvantage, DE-A-(File No.: 8178Z) proposes a shift device for a transmission with a cam drive, which has a shifting roll with at least one groove, wherewith, at least one selector finger engages itself therein so that, upon a rotation of the shifting roll, the selector finger moves axially and whereby the groove possesses for shifting up, an upgear groove designed as an upward shifting path and, conversely, for downshifting, has a downshift path. In this design, the downshift path is constructed as a downshift groove, which conducts the selector finger, during downshifting or during multiple-downshifting, into a axial shift position equivalent to a neutral position.

The downshift groove is provided with an effective blocking means, which is active during a shifting roll direction of rotation equivalent to an upshift so that the selector finger, during an upshift is guided by the upshifting groove and during a downshift is guided by a downshift groove.

By way of this design of the downshift path as a downshift groove, which places the selector finger into a shifting position equivalent to a neutral position during a multiple-downshift occurrence, it is possible that multiple-downshift operations can be carried out without a running through of sequential gear stages, whereby shorter shifting times can be achieved.

The provision of a blockage apparatus in the downshift groove, which is effective in a direction of rotation of the shifting roll equivalent to a upgear shift direction thereof, leads to a situation where the shifting roll is guided through an upshift groove during an upshift and during a multiple-downshifting is guided through a downshift groove to the end that the selector finger upon upshift or, during multiple-upshifting, is guided by the sequential upshift path and during multiple-downshifting is guided in a direct path into its neutral position. Thereby, the desired reduction of the shifting time is achieved by multiple-downshifting.

In the case of the above described known shift device, however, a multi-path of the shifting roll is yet to be considered and also a reversal of the direction of rotation of the shifting roll between the upshifting and the downshifting is necessary.

The purpose of the present invention is to create a device, with which the gear stages both, in the case of upshifting as well as downshifting, are freely selectable without a sequential run through gear stage positions, and without the necessity that a multi-path course of the shifting roll must be run through or a reversal of the direction of rotation thereof becomes necessary.

### SUMMARY OF THE INVENTION

The proposal is made that a shift device be designed as a passive, speed of rotation controlled system, wherein finding the goal to be attained, for either upshifting or downshifting, would be considered as a function of the speed of rotation of the shifting roll, which attainment would be enabled by centrifugal force engendered by the speed of rotation.

According to the invention, provision has been made within the framework of an advantageous embodiment of the present invention that rocker-elements are placed on the outer circumference of the shifting roll, which rocker elements have wedge-shaped tips. These tips are so placed about a turning axle that they can engage themselves into an appropriate groove, whereby the axle of rotation is parallel to the groove and whereby a compression spring is located on one side of the turning axle of the rocker element. In this way, the wedge-shaped tips of the rocker elements determine the path of the selection fingers for both upshifting and downshifting. The compression spring, which exerts its force upon the rocker element, serves to make certain that if a shifting roll is rotating slowly, the wedge-shaped tips of the rocker elements so engage in a groove. If the shifting fork finds itself in the neutral position with the shifting finger and the shifting roll turns back, the shifting finger, as in a case with conventional shift devices, transfers out of the neutral groove and into the (inclined) gear groove so that a desired gear position is obtained.

Conversely, if the shifting roll is rotating more rapidly then the rotational axle for the rocker element, which axle is located symmetrically beside the groove, carries out an action, so that a torque is brought about on the rocker element, because of increased centrifugal force, to the end that the spring force is opposed. By this activity, the rocker element pivots about its axle of rotation, so that the wedge-shaped tips are forced out of engagement with the groove. The selector finger, as a result, is no longer diverted into the direction of the gear groove, but is allowed to remain in the neutral position.

When upshifting occurs, then the operational principle reverses itself, because of the asymmetrical arrangement of the rocker element. That is to say that in a case of slower rotation of the shifting roll, the selector finger remains in the neutral position and upon a more rapid rotation thereof, is directed into the gear groove.

The invented design of the shift device offers more advantages. First, an additional actuator can be eliminated, since now a “passive” employment of the centrifugal force on these grounds, has the effect that gear stages, both in upshifting and downshifting, become freely selectable so that a running through of gear sequences can be done away with. Second, there is no necessity that the shifting roll must travel through a multi-gear path nor carry out a reverse of direction, because no greater paths exist to force such action.

In a case of simple shifting, because of an identical shifting procedure, the same shifting time is necessary as in the case of the conventional shift devices which have a shifting roll. In the case of multiple shifts, the desired gear position is found directly without multiple paths and without a rotational direction reversal of the shifting roll. In this way, a clear diminution of the shifting times has been achieved, because of the elimination of the no longer needed mutual synchronization.

### BRIEF DESCRIPTION OF THE DRAWINGS

The invention will now be described, by way of example, with reference to the accompanying drawings in which:

The single FIGURE is a development of a shifting roll.

### DETAILED DESCRIPTION OF THE INVENTION

Since shift devices with shifting rolls are well known to the expert, in the given FIGURE only those components which are necessary for understanding the invention are presented in a purely schematic manner.

The rocker elements, which find their place on the outer circumference of the shifting roll, are designated with the reference number 8, whereby these turn about a rotational axle 6, which axle is set to be parallel along side of the corresponding groove. Each groove of the shifting roll possesses an encircling neutral groove, which has a connection with the appropriate gear stage. The rocker elements 8 are provided, on one side with wedge-shaped tips 1, 2, 3, 4, 5 and, on the other side, with wedge-shaped tips 10, 11, 12, 13, 14 and are so placed that the wedge-shaped tips 1, 2, 3, 4, 5 determine the path of the selector fingers during upshift and downshift. For this purpose, the one side of each rotational axle 6 of each rocker element 8 is so loaded by a compression spring 9, that the associated wedge-shaped tips engage in the groove.

The force of the spring 9 is so regulated that, during a slow rotation of the shifting roll, the engagement of the wedge-shaped tip remains in place so that, if the shifting fork finds itself with the corresponding selector finger in the neutral position and the shifting roll turns backwards, the selector finger is diverted out of the neutral groove and transferred to the gear stage groove in the same manner as is carried out in the case of the conventional shift devices which have shifting rolls.

Otherwise, in the event of a quick rotational reversal of the shifting roll, because of the asymmetrical design of the rocker elements 8 on their rotational axes 6, the rocker element is subjected to a torque, due to the occurring centrifugal force, which works counter to the force of the spring 9 so that the rocker element pivots and its wedge-shaped tip cannot engage itself in the groove. By this means, the selector finger is no longer diverted, but remains in the neutral position as a result of this quick rotational reversal of the shifting roll.

The operating principle reverses itself in the case of upshifts so that, in such cases, upon a slow turning of the shifting roll, the selector finger remains in the neutral position and, contrarily, upon a rapid turning of the shifting roll, is diverted in the direction of the shifting groove.

In the following, the functioning of the invented shift device is explained in details.

Simple Downshift

The shifting roll is slowly reversed, under which circumstances, the force of the compression spring 9 is greater than the torque called up by centrifugal force. As a result, the wedge-shaped tips 1, 2, 3, 4, 5 of the rocker element 8 remain in neutral engagement and are capable of being shifted in a sequential manner. This is inevitable if the force of the spring is not overpowered by centrifugal force.

Multiple (Double) Downshifting

The shifting roll is, first, placed in rapid, reverse speed of rotation. As this occurs, the wedge-shaped tips 1, 2, 3, 4, 5 of the rocker elements 8 are not in engagement with a respective groove so that the selector finger remains in the neutral position. Following the occurrence of the corresponding rocker element 8 (before the desired gear stage), the speed of rotation of the shifting roll is reduced to such an extent that all rocker elements are again in a groove engagement. The selector finger is now diverted in the gear groove and the corresponding gear position is attained.

Simple Upshifting

The shifting roll is turned at a high rotational speed, so that the rocker elements 8 are in groove engagement by their wedge-shaped tips 10, 11, 12, 13, 14 and shifting in a sequential manner is possible.

Multiple (Double) Upshifting

The shifting roll is turned at a slow speed in the direction of upshifting so that the deflecting wedge-shaped tips 10, 11, 12, 13, 14 are not in groove engagement and the selector finger remains in the neutral position. Before the desired gear stage is shifted into, the shifting roll is rotated rapidly so that now the wedge-shaped tips 10, 11, 12, 13, 14 are in groove-engagement and the desired gear stage is shifted into.

The invented embodiment of the shift device also enables a passively, regulated choice for upshifting as well as for down shifting, these serving as a function of the speed of rotation of the shifting roll and with the usage of the centrifugal force which arises thereby. Although an especially advantageous embodiment has been described, the fundamental concept of the invention can be applied to additional appropriate operations.

### REFERENCE NUMERALS

1 tip
2 tip
3 tip
4 tip
5 tip
6 axle of rotation for rocker element
8 rocker element carrying tips and spring
9 compression spring
10 tip
11 tip
12 tip
13 tip
14 tip

1-4. (canceled)

5. A shift device for a transmission with a cam drive, which has a shifting roll rotatably guided about an axle, the shifting roll having grooves, as well as a selection finger which can engage in the grooves, the shift device is designed as a passive, speed of rotation regulated system, a choice of a desired gear stage for upshifting as well as downshifting is enabled as a function of the speed of rotation of the shifting roll and in presence of an occurring centrifugal force.

6. The shift device according to claim 5, wherein on an outer circumference of the shifting roll, rocking elements (8) are supported on rotatable axles (6) which are provided on both ends respectively with wedge-shaped tips (1, 2, 3, 4, 5; 10, 11, 12, 13, 14), on one side of the rotatable axle (6) a compression spring (9) is placed, which exerts a force upon the wedge-shaped tips (1, 2, 3, 4, 5), which on the rocking element (8) are located on an end of the rocker element which is remote from the compression spring (9).

7. The shift device according to claim 6, wherein the rotatable axle (6) is asymmetrically placed in reference to a corresponding groove.

8. The shift device according to claim 6, wherein a neutral groove is bound to each gear stage groove of the shifting roll.
